(19) United States
(12) Patent Application Publication
(10) Pub. No.: US 2022/0397240 A1
(43) Pub. Date: Dec. 15, 2022

(54) LIQUID HYDROGEN STORAGE

(71) Applicant: MAGNA STEYR Fahrzeugtechnik AG & Co KG, Graz (AT)

(72) Inventors: Guido BARTLOK, Graz (AT); Daniel KUPELWIESER, Graz (AT)

(21) Appl. No.: 17/837,162

(22) Filed: Jun. 10, 2022

(30) Foreign Application Priority Data
Jun. 10, 2021 (DE) 102021205920.1

(51) Int. Cl. F17C 13/00; B01F 25/312; B01F 23/10

(52) U.S. Cl. CPC F17C 13/006; B01F 25/312; B01F 23/12; F17C 2221/012; F17C 2223/0161; F17C 2205/0352; F17C 2265/031; F17C 2205/0323

(57) ABSTRACT

A liquid hydrogen store including a cryostatic container for holding the liquid hydrogen, a discharge line for discharge of gaseous hydrogen, a boil-off management system, a boil-off valve in the discharge line for selective opening and closing of a fluidic connection of the discharge line to the boil-off management system, a heat transport line, and one or more thermal contact members to establish thermal contact of the heat transport line with the boil-off management system.

### CROSS-REFERENCE TO RELATED APPLICATIONS

The present application claims priority 35 U.S.C. § 119 to German Patent Publication No. DE 102021205920.1 (filed on Jun. 10, 2021), which is hereby incorporated by reference in its entirety.

### TECHNICAL FIELD

Embodiments relate to a liquid hydrogen store comprising a cryostatic container for holding the liquid hydrogen, and a method for operating such a liquid hydrogen store.

### BACKGROUND

It is known to use cryostatic containers for storing liquid, low-boiling or cryogenic hydrogen, in particular, for carrying liquid hydrogen in hydrogen-operated motor vehicles, for example, in fuel-cell vehicles.

Due to the unavoidable input of heat into the cryostatic container of a fuel-cell vehicle which is operated with liquid hydrogen, evaporation of hydrogen occurs continuously. Should extraction of a corresponding extent not be realized for the hydrogen consumer, the pressure in the tank rises.

In order to keep the pressure in the tank below a particular threshold value, it is possible in the case of such liquid hydrogen stores for a valve, specifically a so-called “boil-off valve” (BOV), to open, whereby gaseous hydrogen is discharged into the surroundings.

In order to rule out any hazard, for example, an explosion, due to excessively high hydrogen concentrations in the surroundings, the released gas can be catalytically converted with the oxygen in the ambient air and thereby reacts to form water vapour. This system is referred to as boil-off management system (BMS). As soon as the BOV opens, gaseous hydrogen, under high pressure, flows from the cryogenic tank. Said gaseous hydrogen is then blown through a nozzle into a mixing chamber, in which sucked-in air, in particular ambient air, is mixed with the hydrogen and transported along therewith in the direction of a catalytic converter. Finally, the catalytic conversion of the blown-away hydrogen takes place in the catalytic converter.

For example, German Patent Publication No. DE 10 2016 209 170 A1 discloses a method for checking the functional capability of a catalytic converter for converting a fuel, in particular hydrogen, in a vehicle, wherein, via a connecting line, the catalytic converter is connected fluidically to a pressure vessel for storing the fuel, wherein a relief valve is arranged in the connecting line and is designed to allow fuel to pass to the catalytic converter when the pressure of the fuel in the pressure vessel exceeds a pressure value.

German Patent Publication No. DE 10 2014 015 987 A1 discloses a method for operating a hydrogen filling station, having at least one storage container which serves for storing liquefied hydrogen and in which boil-off gas is generated at least intermittently, having at least one cryogenic pump which serves for compressing the hydrogen to the desired discharge pressure, having at least one dispenser via which the compressed hydrogen is discharged, and having the aforementioned component-connecting lines, wherein the boil-off gas generated in the at least one storage container serves at least partially for cooling at least one component and/or line of the hydrogen filling station and/or is catalytically combusted at least partially.

German Patent Publication No. DE 102 02 171 A1 discloses a motor vehicle having a cryogenic tank for providing a supply to an internal combustion engine which drives the motor vehicle and which is assigned an exhaust-gas system with an exhaust-gas catalytic converter, and having a device for combustion of boil-off gas from the cryogenic tank, wherein the boil-off gas is introduced into the exhaust-gas system of the internal combustion engine close to an exhaust-gas catalytic converter.

Since the outflowing hydrogen (the boil-off gas) is very cold (normal boiling point of approximately 20 K), a relatively long period of operation of the BMS results in ice forming on the H2 line of the BMS due to the water vapour contained in the ambient air. Liquefaction of ambient air is also possible here. Consequently, unfavourable ambient conditions (ambient temperature just above the freezing point of water, high air humidity) can also result in heavy ice formation and damage to components and, in the event of liquefied ambient air making contact with flammable substances on the ground, a high risk of fire. Since negative pressure prevails in the mixing chamber of the BMS, in the case of unfavourable ambient conditions, particularly in the case of the ambient temperature being just above the freezing point of water and high air humidity, there is the risk of “carburettor icing”, that is to say ice formation in the mixing chamber due to the water vapour contained in the ambient air. Over time, this would lead to loading of the catalytic converter with pure hydrogen and thus to malfunctioning of the system.

### SUMMARY

In accordance with embodiments, an enhanced improve liquid hydrogen store is provided which can be operated reliably, even at high boil-off rates of liquid hydrogen, which are typical for heavy traffic. Such a liquid hydrogen store has a short hydrogen feed line or one that is flowed around poorly by ambient air, and even at low ambient temperatures and high air humidity. In particular, air liquefaction and/or ice formation are/is to be efficiently prevented and the temperature and thus the density of the hydrogen flowing through the nozzle of the BMS are to be kept in a particular range.

In accordance with embodiments, a liquid hydrogen store comprises a cryostatic container for holding the liquid hydrogen, a discharge line for discharge of gaseous hydrogen, and a boil-off valve in the discharge line for selective opening and closing of a fluidic connection of the discharge line to a boil-off management system, wherein the boil-off management system comprises a mixing chamber for mixing of the gaseous hydrogen with air, wherein, downstream of the mixing chamber, the boil-off management system comprises a catalytic converter for catalytic conversion of the gaseous hydrogen with the air, wherein, downstream of the catalytic converter, the boil-off management system comprises an exhaust line for discharge of the gas stream to the surroundings, wherein the liquid hydrogen store comprises a heat transport line, wherein one or more thermal contact members is provided to establish thermal contact of the heat transport line with respect to the catalytic converter, and/or an enclosure of the catalytic converter, and/or the exhaust line, the mixing chamber, and/or the air feed line, and/or the discharge line, and/or the boil-off valve, and/or a manifold block (in particular ahead of safety valves).

In accordance with embodiments, a liquid hydrogen store has a boil-off management system in which a heat transport line is configured in such a way that, at one side, it has one or more thermal contact members in a warm region, specifically at the catalytic converter, and/or with respect to the enclosure of the catalytic converter, and/or at the exhaust line, in order, there, to absorb the heat and to transport said heat via the heat transport line to a cold discharge region for the heat, specifically via thermal contact of the heat transport line with respect to the mixing chamber and/or with respect to the air feed and/or with respect to the discharge line and/or with respect to the boil-off valve and/or neighbouring components, such as for example a manifold block, in particular ahead of safety valves, so that, in this way, the mixing chamber and/or the air feed and/or the boil-off valve and/or the valve manifold block and/or a neighbouring component of the discharge line are/is heated.

Such a heat transport line with one or more thermal contact members makes possible heating, directly or indirectly, of the mixing chamber and of parts of the hydrogen discharge lines, including branches, valves and nozzles or fittings, and also of the hydrogen fed to the BMS itself and of the air fed to the BMS and consequently avoidance of ice formation in this region.

At the same time, the one or more thermal contact members may be selected in such a way that undesired overheating and consequently a risk of inflammation in the region of an inflow nozzle or damage to components of the BMS or neighbouring components or heating of the hydrogen in the discharge line that is not permissible for the operation of the BMS cannot occur.

Furthermore, a relatively high temperature of the hydrogen results in a relatively low density thereof and thus to relatively low thermal loading of the catalytic converter situated in BMS, whereby the latter may in this case have relatively small dimensions.

It is also the case that such a heat transport line may be realized inexpensively and with a low weight.

The heat transport line may in particular use direct heat conduction and/or indirect heat conduction by way of heat radiation or convection.

One or more embodiments consequently make possible heating of the air sucked into the mixing chamber of the BMS and/or, directly or indirectly, of the mixing chamber and/or of parts of the hydrogen discharge line, including branches, valves, such as in particular the boil-off valve, nozzles, fittings, manifold blocks, and/or of the hydrogen fed to the BMS itself, specifically preferably in a purely passive manner, that is to say in particular without the need for electrical current. For this purpose, according to the invention, use is made of the waste heat of the BMS catalytic converter. The exhaust-gas stream is preferably not impeded in this case.

Refinements of one or more embodiments are specified in the dependent claims, the description and the appended drawings.

Preferably, the heat transport line is formed by a solid-body heat bridge, and/or is formed by a heat pipe through which a working medium flows and which is characterized in particular by phase transitions, convection of gas and capillary transport of the working medium. It is also possible for a working medium to be allowed to circulate, or to be controlled, via an active drive, for example a pump and/or a valve.

The liquid hydrogen store preferably comprises a cover, wherein the discharge line comprises an internal section, which runs within the cover, and comprises an external section, which runs outside the cover. One or more thermal contact members to establish thermal contact of the heat transport line is preferably configured with respect to the external section of the discharge line and/or with respect to the internal section of the discharge line.

Preferably, the liquid hydrogen store comprises fittings at the discharge line, in particular for extraction of hydrogen from the cryostatic container, wherein the fittings are covered by the cover. Preferably, the cryostatic container itself is also covered by the cover, or the cover forms a part of a housing around the cryostatic container.

Preferably, one or more thermal contact members to establish, in particular direct thermal contact by way of heat conduction and/or indirectly by way of heat radiation or convection, of the heat transport line is configured with respect to the mixing chamber and with respect to the external section of the discharge line, wherein the one or more thermal contact members at the external section of the discharge line is configured in particular for an equal and/or greater and/or lesser transfer of heat than the one or more thermal contact members of the heat transport line with respect to the mixing chamber. At the mixing chamber, by way of one or more thermal contact members at the surfaces of chamber and air inlet, heat is to be fed thereto and in this way the icing thereof in the case of outside temperatures just above the freezing point of water (carburettor icing) is to be prevented, but at the same time, through suitable design of the one or more thermal contact members, excessive heating in the case of high outside temperatures is to be prevented. At the external section of the discharge line for boil-off hydrogen, relatively constant cryogenic temperatures (typically up to at least approximately 30 K) prevail in the line, and external icing of the line and air liquefaction are most critical there. Conversely, a possible greater input of heat is less problematic here. It is therefore possible for the one or more thermal contact members at the external section of the discharge line to be configured for great feeding of heat and also a constant temperature gradient, wherein, for the function of the BMS, the density and thus the temperature of the hydrogen itself are critical, and for this reason these must be neither too low nor too high at the nozzle.

Preferably, one or more thermal contact members of the heat transport line is configured with respect to the external section of the discharge line and with respect to the internal section of the discharge line, wherein the one or more thermal contact members at the external section of the discharge line is configured for an equal and/or greater and/or lesser transfer of heat than the one or more thermal contact members of the heat transport line with respect to the internal section of the discharge line. The internal line for boil-off hydrogen normally likewise has constant cryogenic temperatures. Here, icing is less critical, since, due to the cover of the fittings and the possible icing thereof, a certain insulation effect occurs. An excessively great input of heat, particularly into the surroundings of the one or more thermal contact members with respect to the internal section of the discharge line, must not take place, since otherwise sensitive components could be damaged.

Preferably, the feeding of the air into the mixing chamber is realized via the Venturi principle and thus passively, in particular without the need for electrical current.

### DRAWINGS

Embodiments will be illustrated by way of example in the drawings and explained in the description hereinbelow.

FIG. 1 illustrates a schematic illustration of a liquid hydrogen store in accordance with one or more embodiments.

### DESCRIPTION

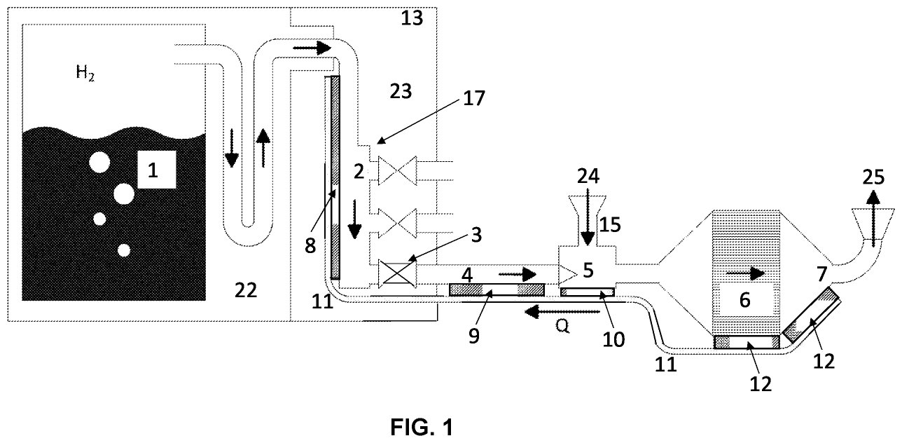

FIG. 1 illustrates a liquid hydrogen store in accordance with one or more embodiments. The liquid hydrogen store comprises a cryostatic container 1 for holding the liquid hydrogen. The hydrogen H2 is in liquid form in the lower region of the cryostatic container 1 and is in gas form in the upper region of the container 1. A discharge line 2, 4 is configured for discharge of gaseous hydrogen from the upper region of the cryogenic container 1 and runs sectionally through a region of the liquid hydrogen store that has a vacuum 22 and through a region of the liquid hydrogen store that has air 23, in particular ambient air, to the outside.

In the region of the liquid hydrogen store that has air 23, the liquid hydrogen store comprises fittings 17 at the discharge line 2. The liquid hydrogen store comprises a cover 13. The fittings 17 are covered by the cover 13. The discharge line 2, 4 comprises an internal section 2, which runs within the cover 13 of the liquid hydrogen store, and an external section 4, which runs outside the cover 13.

The liquid hydrogen store furthermore comprises a boil-off valve 3 in the discharge line 2 for selective opening and closing of a fluidic connection of the discharge line 2, 4 to a boil-off management system, wherein the boil-off management system comprises a nozzle for discharge of the hydrogen, wherein, downstream of the nozzle, the boil-off management system comprises a mixing chamber 5 for mixing of the gaseous hydrogen with air, in particular ambient air, wherein, downstream of the mixing chamber 5, the boil-off management system comprises a catalytic converter 6 for catalytic conversion of the gaseous hydrogen with the air, in particular ambient air, wherein, downstream of the catalytic converter 6, the boil-off management system comprises an exhaust line 7 for discharge of the gas stream to the surroundings. The gas stream is discharged into the surroundings through an exhaust-gas outlet 25 via the exhaust line 7.

The selective opening and closing of the fluidic connection by the boil-off valve 3 may be realized for example in a pressure-controlled and/or pressure-regulated manner.

An air feed line 15 allows ambient air to be received through an air inlet 24 to the mixing chamber 5. The feeding of the air into the mixing chamber 5 is realized via the Venturi principle, by way of suction action of the media flowing past, and is thus realized passively, without electrical components.

In accordance with one or more embodiments, the liquid hydrogen store comprises a heat transport line 11, which is formed by a solid-body heat bridge, and/or is formed by a heat pipe through which a working medium flows. The heat transport line 11 extends from the internal section 2 of the discharge line 2, 4 as far as the exhaust line 7. The heat transport line 11 could, according to requirement, also be designed to be significantly shorter and also extend only as far as the catalytic converter 6 or only as far as the enclosure of the catalytic converter 6 (not illustrated).

One or more thermal contact members 12 of the heat transport line 11 is configured in each case with respect to the catalytic converter 6 and/or with respect to the enclosure of the catalytic converter 6 and with respect to the exhaust line 7, that is to say in warm regions where heat is transferred to the heat transport line 11, and, at the other side, with respect to the mixing chamber 5 and/or with respect to the air feed 15, with respect to the external discharge line 4 and with respect to the internal discharge line 2, where heat is released in each case. The direction of the flow of heat Q (arrow) is illustrated in the figure and is in the direction counter to the direction of the outflowing hydrogen H2 (further arrows) or in the direction from warm parts to cold parts of the liquid hydrogen store or of the BMS.

The one or more thermal contact members 9 at the external section 4 of the discharge line 2, 4 is configured here for example for a greater transfer of heat than the one or more thermal contact members 10 of the heat transport line 11 with respect to the mixing chamber 5.

The one or more thermal contact members 9 at the external section 4 of the discharge line 2, 4 is also configured here for example for a greater transfer of heat than the one or more thermal contact members 8 of the heat transport line 11 with respect to the internal section 2 of the discharge line 2, 4.

In accordance with one or more embodiments, it is consequently the case that waste heat from the catalytic converter of the boil-off management system (BMS) of a vehicle operated with liquid hydrogen is fed via solid-body heat conduction and/or heat pipes to the cold regions of the BMS, in particular the H2 feed lines 2, 4 and the mixing chamber 5 and/or the air feed line 15, in order to heat these and thereby avoid ice formation, air liquefaction and an excessively high density of the hydrogen gas upstream of the nozzle.

The surface of the catalytic converter 6 and/or the enclosure of the catalytic converter and of the exhaust pipe 7 of the boil-off management system (BMS) is suitably contacted thermally 12, and a part of the waste heat is transported to the cold regions of the BMS via a solid-body heat bridge or a heat-pipe arrangement 11 with a suitable working medium, or multiple different suitable working media. In said cold regions, the heat is fed to the critical components via suitable one or more thermal contact members 8, 9, 10. Said critical components are:

Firstly: the mixing chamber 5, where, by way of one or more thermal contact members 10 of the surfaces of chamber and air feed line 15, heat is fed thereto and in this way the icing thereof in the case of outside temperatures just above the freezing point of water is to be prevented, but at the same time, through suitable design, excessive heating in the case of high outside temperatures is prevented.

Secondly: the external line for boil-off hydrogen 4, where relatively constant cryogenic temperatures prevail in the line and external icing of the line and air liquefaction are most critical. At the same time, an excessively high temperature and consequently an excessively low density of the hydrogen gas upstream of the nozzle is to be avoided here, in order to be able to process all the boil-off gas generated. Conversely, a possible greater input of heat, owing to the position of the line, is less problematic here, it therefore being possible for the one or more thermal contact members 9 to be configured for great feeding of heat and also a constant temperature gradient.

Thirdly: the internal line for boil-off hydrogen 2: Constant cryogenic temperatures (up to at least approximately 30 K) likewise prevail here. Here, icing is less critical, since, due to the cover of the fittings 13, a certain shielding or a certain insulation effect with respect to the surroundings occurs. An excessively great input of heat, particularly also into the surroundings of the one or more thermal contact members 8, must not take place here, since otherwise sensitive components could be damaged.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Cryostatic container

2 Discharge line, internal section

3 Boil-off valve

4 Discharge line, external section

5 Mixing chamber

6 Catalytic converter

7 Exhaust line

8, 9, 10, 12 Thermal contact members

11 Heat transport line

13 Cover

15 Air feed line

17 Fittings

22 Vacuum

23 Air

24 Air inlet

25 Exhaust-gas outlet

H2 Hydrogen

Q Flow of heat

What is claimed is:

1. A liquid hydrogen store, comprising:
a cryostatic container for holding the liquid hydrogen;
a discharge line for discharge of gaseous hydrogen;
a boil-off management system that includes a mixing chamber for mixing the gaseous hydrogen with ambient air, a catalytic converter arranged downstream of the mixing chamber for catalytic conversion of the gaseous hydrogen with the ambient air, and an exhaust line arranged downstream of the catalytic converter for discharge of a gas stream to the ambient environment;
a boil-off valve in the discharge line for selective opening and closing of a fluidic connection of the discharge line to the boil-off management system;
a heat transport line; and
one or more thermal contact members to establish thermal contact of the heat transport line with the catalytic converter, and/or an enclosure of the catalytic converter, and/or the exhaust line, the mixing chamber, and/or the discharge line, and/or the boil-off valve.

2. The liquid hydrogen store of claim 1, wherein the heat transport line is formed by a solid-body heat bridge.

3. The liquid hydrogen store of claim 2, wherein the heat transport line is formed by a heat pipe through which a working medium flows.

4. The liquid hydrogen store of claim 1, wherein:
the liquid hydrogen store comprises a cover, and
the discharge line comprises an internal section which extends within the cover and an external section which extends outside the cover,
the one or more thermal contact members establish in thermal contact of the heat transport line with the internal section and the external section.

5. The liquid hydrogen store of claim 4, further comprising fittings at the discharge line which are covered by the cover.

6. The liquid hydrogen store of claim 4, wherein the one or more thermal contact members at the external section is configured for a greater transfer of heat than the one or more thermal contact members at the mixing chamber.

7. The liquid hydrogen store of claim 4, wherein the one or more thermal contact members at the external section of the discharge line is configured for a greater transfer of heat than the one or more thermal contact members at the internal section of the discharge line.

8. The liquid hydrogen store of claim 1, wherein the ambient air is fed into the mixing chamber via the Venturi principle.

9. The liquid hydrogen store of claim 1, further comprising an air feed line to facilitate a flow of the ambient air to the mixing chamber via the Venturi principle.

10. The liquid hydrogen store of claim 9, wherein the one or more thermal contact members are configured to establish thermal contact of the heat transport line with the air feed line.

11. A liquid hydrogen store, comprising:
a cryostatic container for holding the liquid hydrogen;
a discharge line for discharge of gaseous hydrogen;
a boil-off management system that includes a mixing chamber for mixing the gaseous hydrogen with ambient air, a catalytic converter arranged downstream of the mixing chamber for catalytic conversion of the gaseous hydrogen with the ambient air, and an exhaust line arranged downstream of the catalytic converter for discharge of a gas stream to the ambient environment;
a boil-off valve in the discharge line for selective opening and closing of a fluidic connection of the discharge line to the boil-off management system;
a heat transport line; and
one or more thermal contact members to establish thermal contact of the heat transport line with the boil-off management system.

12. The liquid hydrogen store of claim 11, wherein the liquid hydrogen store comprises a cover.

13. The liquid hydrogen store of claim 12, wherein the discharge line comprises an internal section which extends within the cover and an external section which extends outside the cover.

14. The liquid hydrogen store of claim 13, wherein the one or more thermal contact members are to establish thermal contact of the heat transport line with the internal section and the external section.

15. The liquid hydrogen store of claim 14, wherein the one or more thermal contact members at the external section is configured for a greater transfer of heat than the one or more thermal contact members at the mixing chamber.

16. The liquid hydrogen store of claim 14, wherein the one or more thermal contact members at the external section is configured for a greater transfer of heat than the one or more thermal contact members at the internal section.

17. The liquid hydrogen store of claim 11, wherein the ambient air is fed into the mixing chamber via the Venturi principle.

18. The liquid hydrogen store of claim 11, further comprising an air feed line to facilitate a flow of the ambient air to the mixing chamber via the Venturi principle.

19. The liquid hydrogen store of claim 18, wherein the one or more thermal contact members are configured to establish thermal contact of the heat transport line with the air feed line.

20. A liquid hydrogen store, comprising:
a cryostatic container for holding the liquid hydrogen;
a discharge line for discharge of gaseous hydrogen;
a boil-off management system that includes a mixing chamber for mixing the gaseous hydrogen with ambient air, a catalytic converter for catalytic conversion of the gaseous hydrogen with the ambient air, and an exhaust line for discharge of a gas stream to the ambient environment;
a boil-off valve in the discharge line for selective opening and closing of a fluidic connection of the discharge line to the boil-off management system;
a heat transport line; and
one or more thermal contact members to establish thermal contact of the heat transport line with the boil-off management system.
